(19) United States
(12) Patent Application Publication
(10) Pub. No.: US 2002/0073156 A1
(43) Pub. Date: Jun. 13, 2002

(54) Method and system for mail folder displays

(75) Inventor: Paula S. Newman, Los Altos, CA (US)

Correspondence Address: Gunnar G. Leinberg, Esq., NIXON PEABODY LLP., Clinton Square, P. O. Box 31051, Rochester, NY, 14603-1051, US

(73) Assignee: Xerox Corporation

(21) Appl. No.: 09/732,023

(22) Filed: Dec. 8, 2000

(51) Int. Cl. G06F 15/16

(52) U.S. Cl. 709/206

(57) ABSTRACT

A method and apparatus for displaying mail folders. Each display treatment can present messages in different categories at various levels of granularity and messages in a particular category can be presented in various ways on alternative displays. Additionally, categories can be nested and the nesting can be reflected in different ways on different displays.

### FIELD OF THE INVENTION

The present invention relates generally to the field of information display and, in particular, the display of information in mail folder displays.

### BACKGROUND OF THE INVENTION

High inbox volumes are a recognized problem. Large collections of undifferentiated messages often make it difficult to notice new or recent messages of importance, and to find and select messages of a particular type. This problem is fairly acute. Many people maintain inboxes containing over 1,000 messages. The messages are accumulated: (a) as reminders of, and source material for, things to do; (b) for reference; and (c) for deferred reading. Additionally, messages can accumulate when people are away from their mail folders. It is not unusual for 500 or more messages to arrive in a typical user's inbox during a 2-week vacation.

The importance of inbox messages vary. The importance ranges from critical messages from immediate working groups and customers, to messages from mailing lists associated with personal hobbies.

Conventional e-mail processors such as Outlook®, Lotus Notes®, and Eudora®, provide some ways to deal with the volume problem. They permit the specification of rules to categorize messages and to shunt all messages in some categories, on receipt, to secondary folders. However, many people want to be aware of all messages received, at least to some extent, whatever the degree of importance of the messages.

Another conventional approach, available in Outlook®, allows people to view mail folders via an hierarchic organization, with up to three levels. These levels include: (1) rule-based categories; (2) subjects; and (3) lists of specific messages. Using the full three levels prevents large volumes of low-priority messages from obscuring higher priority messages. However, using such a three level hierarchic organization also involves a variety of actions to determine whether some new, important mail has been received, and, if so, what the e-mail might be concerning. The actions include: 1) requesting the hierarchic display; 2) expanding a category of interest; 3) expanding a subject of interest; and 4) selecting individual items from that subject for viewing.

An e-mail processor should allow people to quickly identify, and focus on, only the most critical messages when serious time constraints apply, and to catch up on lower priority messages at other times.

### SUMMARY OF THE INVENTION

The present invention recognizes that users access their inboxes for different purposes at different times. The present invention allow a user to specify, in a relatively simple way, a different inbox (or other folder) display treatment for each such purpose. Each display treatment can present messages from different categories at different, category-specific and display-specific levels of granularity. Also, the messages in a particular category can be presented in different ways on different displays. For example, given two user-specified display treatments D1 and D2, and two categories C1 and C2, display treatment D1 might list all messages from category C1 and omit any from C2, while display treatment D2 might list the subject threads of category C1, and just a single item representing the entire category for messages from category C2.

An embodiment of the present invention allows the specification of many different treatments for messages in a particular category on a particular display. Treatments include: 1) each message from the category is represented by a separate item on the display; 2) each message from the category is represented by a separate item on the display, together with an initial text fragment of the message; 3) messages from the category are grouped into threads and each thread is represented by one item on the inbox display; 4) messages from the category are grouped into threads and each thread is represented by one item on the inbox display together with an initial fragment of the first message in the thread; 5) the set of messages from the category are represented by a single line on the inbox display; and 6) the set of messages from the category are ignored.

In this embodiment, when an item on a display is selected, the associated message or messages are displayed at the next encapsulation level. For example, if a set of messages is represented by a single category-level item, the next level display lists those messages collected into threads. If a set of messages is represented by a single, thread level item, the next level display lists the messages in the thread. At any level, if a display item represents a single message, that message is displayed.

To further facilitate quick absorption of inbox or other folder content, in this embodiment, displays of individual threads are adapted from the presentation described in the patent application entitled METHOD AND SYSTEM FOR DISPLAY OF ELECTRONIC MAIL, Ser. No. (Attorney Docket 001508-003210), filed concurrently herewith, and the disclosure of which is totally incorporated herein by reference. In this application threads are presented as single documents with varying, user-selected amounts of embedded text. In addition, in this embodiment, categories can be nested and the nested categories can be reflected in different ways on different displays. This facilitates comprehensible display of mailing lists that may be entirely divided into, or for example, given two nested categories C1:A and C1:B of parent category C1, the specification of a display D1 can indicate that messages from category C1:A are to be collapsed into category C1, and that messages in category C1:B are to be listed at the thread level.

### BRIEF DESCRIPTION OF THE DRAWINGS

Embodiments of this invention will be described in detail, with reference to the following figures, wherein:

FIG. 1 is a block diagram of a computer controlled display system of an embodiment of the present invention;

FIG. 2 is an outline of a collection of specifications in accordance with one embodiment of the present invention;

FIG. 3 shows a display editor window in accordance with an embodiment of the present invention;

FIG. 4 is an display of e-mails in accordance with the specifications selected in FIG. 3 in accordance with the present invention;

FIG. 5 is an second level display in accordance with an embodiment of the present invention; and

FIG. 6 is an thread level display in accordance with an embodiment of the present invention.

### DETAILED DESCRIPTION OF THE INVENTION

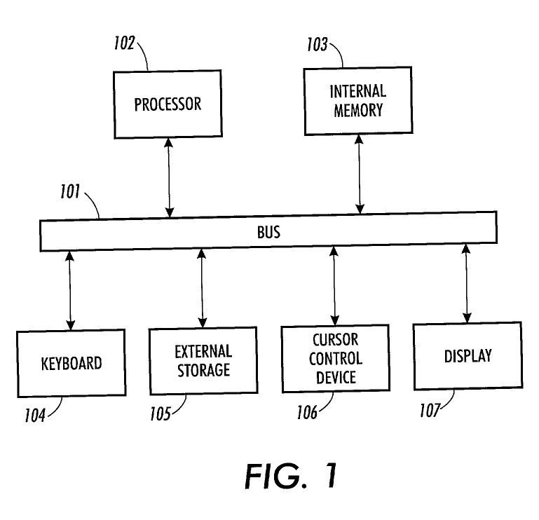

The computer based system of an embodiment of the present invention may be implemented is described with reference to FIG. 1. Referring to FIG. 1, the computer based system 100 is comprised of a plurality of components coupled via a bus 101. The bus 101 may include a plurality of parallel buses (e.g. address, data and status buses) as well as a hierarchy of buses (e.g. a processor bus, a local bus and an I/O bus). In any event, the computer system further includes a processor 102 for executing instructions provided via bus 101 from internal memory 103 (note that the internal memory 103 is typically a combination of random access and read only memories). The processor 102 will be used to perform various operations in support of creating the tree visualizations. Instructions for performing such operations are retrieved from internal memory 103. The processor 102 and internal memory 103 may be discrete components or a single integrated device such as an application specification integrated circuit (ASIC) chip.

Also coupled to the bus 101 are a keyboard 104 for entering alphanumeric input, external storage 105 for storing data, a cursor control device 106 for manipulating a cursor, and a display 107 for displaying visual output. The keyboard 104 would typically be a standard QWERTY keyboard but may also be telephone like keypad. The external storage 105 may be fixed or removable magnetic or optical disk drive. The cursor control device 106, e.g. a mouse or trackball, will typically have a button or switch associated with it to which the performance of certain functions can be programmed.

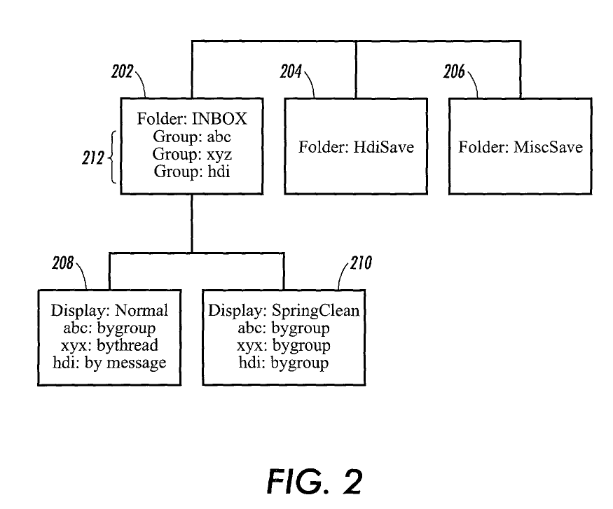

FIG. 2 shows an outline of specifications 200 in accordance with one embodiment of the present invention. The outline 200 includes specifications 202, 204, 206, 208 and 210. In this embodiment, specifications 202, 204 and 206 are specifications for mail folders. The material in each folder may then be divided into rule-based categories 212. For instance, specification 202 for the inbox folder includes three categories, “abc,” “xyz” and “hdi.” Specifications for folders 204 and 206 are not subdivided into categories. Folder 202 is also associated with display specifications 208 and 210 that are appropriate for a different folder access task. For example, display specification 208 is for a user-specified and named “normal” display, while display specification 210 is for a user-specified and named “spring clean” display. The display specification 208 differs from the display specification 210 in that for specification 208 messages in category “abc” are organized by category, messages in category “xyz” are organized by thread and messages in category “hdi” are organized by a message, while, for specification 210, all of the messages in all categories are organized by category.

To further assist in tailored display creation, one embodiment of the present invention (not shown) allows rule-based categories to be nested. Nesting of rule-based categories facilitates comprehensible display of mailing lists that may be entirely divided into, or occasionally contain, easily identifiable generic types of material. For example, a list might be partitioned into discussions, book reviews, conference announcements, etc., and a user may want to see a listing of material in that category subdivided into the different subcategories.

This embodiment of the present invention provides for a nesting of categories by a simple naming criterion in a specification. For example, top-level categories have simple names, e g., “abc.” Nested categories have qualified names, e.g., “abc:xyz” indicating that members of the category must satisfy both the immediate membership rule for the category and the membership rule for the parent. This embodiment includes display specifications that allow for the treatment of subcategories independently of the parent or, alternatively, for the encapsulation of the subcategories within the parents on the top-level display (not shown).

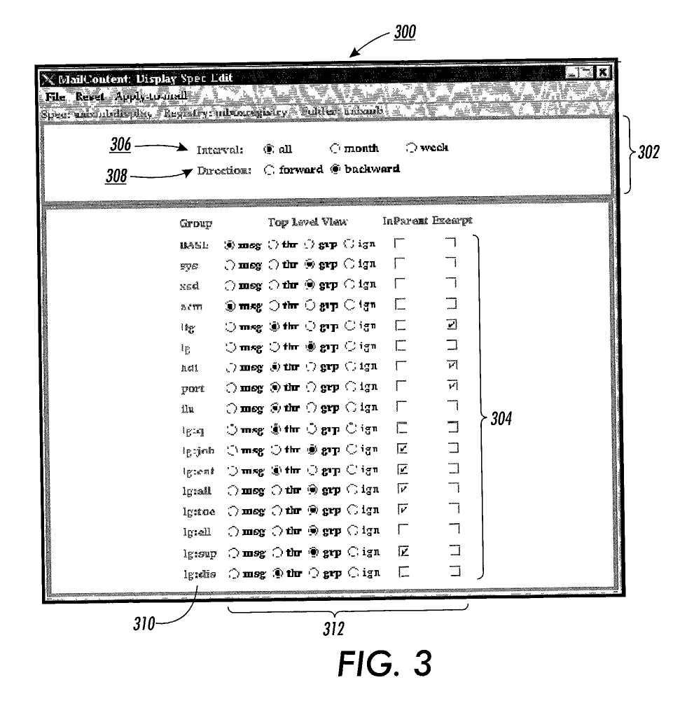

FIG. 3 shows an editor window display 300 in accordance with an embodiment of the present invention. The display 300 is used to create and modify display specifications. The display includes display specifications for display-wide properties 302 and category specific properties 304. The display-wide properties 302 include the interval of interest property 306 and the presentation direction property 308. The display interval property 306 is given in terms of a time period stretching back from the present, such as week, month or all. The display direction property 308 is either “forward” or “backward.” In a forward display, messages are listed at the top level display from the earliest date to the latest. Such a display is suitable for mailbox review and cleanup. Categories, threads and messages are listed at the top level display from the earliest date to the latest. Thus, a category whose first message appears at the earliest date in the period is listed first. In a backward display, categories, threads and messages representing the most recent messages are displayed first. Such a backward display is suitable for quick identification of new material.

The category-specific properties display area 304 of the display 300 enables selection of how messages within the various containing categories are displayed in the folder display. The category-specific properties display area 304 includes a column 310 with category identifiers, along with accompanying user selectable options 312. The user selectable options 312 include the “msg” option which allows each individual message to be listed separately on the display. The options 312 also include the “thr” option which provides each thread in the category to be given one line on the display. The “grp” option provides for each category to be given a single line on the display while the “ign” option provides for the category to be ignored entirely by not displaying the category. Thus, in the example shown in FIG. 3, only messages in the “BASE” and “acm” categories are listed individually. Messages associated with other categories are encapsulated at some level.

For messages belonging to subcategories, the “inparent” option may also be specified. The “inparent” option indicates that messages are entirely capsulated within the parent category at the top-level display. When the parent category is opened, then more specific choices apply. Thus, as shown in FIG. 3 the “lg:job,” “lg:cnf,” “lg:all,” “lg:toc,” and “lg:sup” subcategories are specified to be encapsulated within the parent category “Ig” on the top-level display. Also, all but “lg:cnf” are also encapsulated in the second level display of category “ig.”

Messages and thread items may also be selectively accompanied by a brief but substantive initial message excerpt if the “excerpt” option is selected. For a thread item, the excerpt is taken from the initial message of a thread.

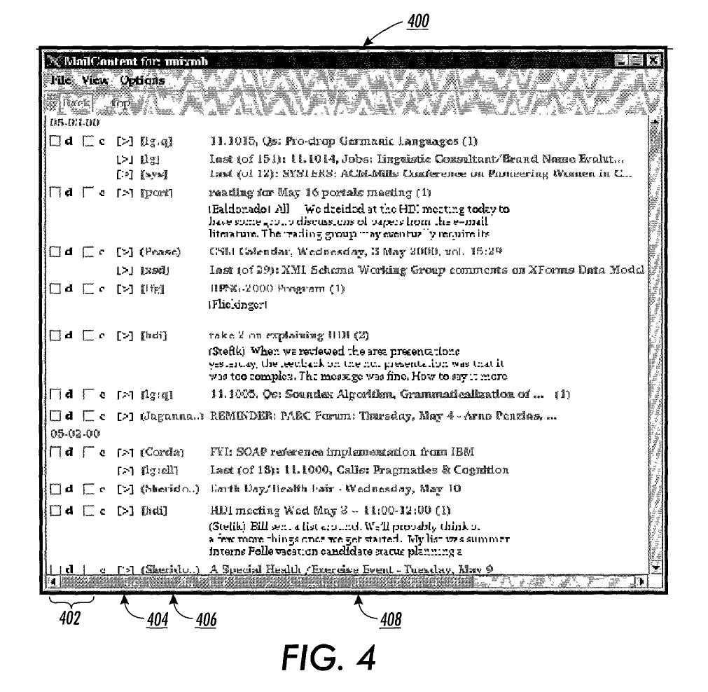

FIG. 4 shows a top-level inbox display 400 in accordance with one embodiment of the present invention. The display 400 was obtained using the display that was specified by the selections made in the display 300 of FIG. 3. Standard display columns provide delete copy choices 402 and a view button 404. The next column 406 provides the message author for unencapsulated messages and the associated category name for threads and categories. The final column 408 provides the subject line for threads and messages and the subject of the most recent thread in the category for encapsulated categories. Each display element representing a collection of messages may be opened to obtain the next level of display to detail the selected category or thread. If, however, a display element directly or indirectly refers to a single message, opening the element results in that message being shown directly.

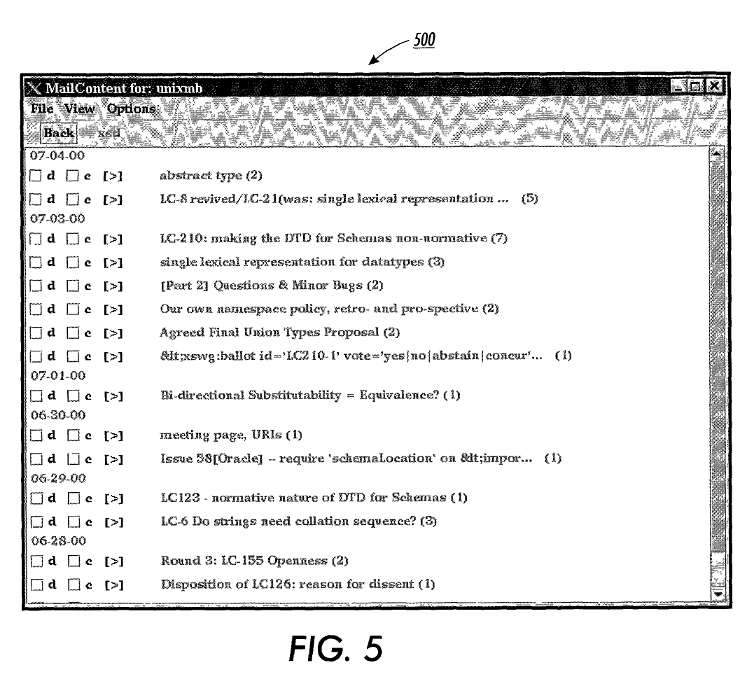

FIG. 5 shows a second level display 500 that was obtained by selecting an encapsulated category on a first level display, in accordance with one embodiment of the present invention. It is similar in form to the first level display 400 except that all the subsumed messages belong to a single category, and are displayed collected into threads.

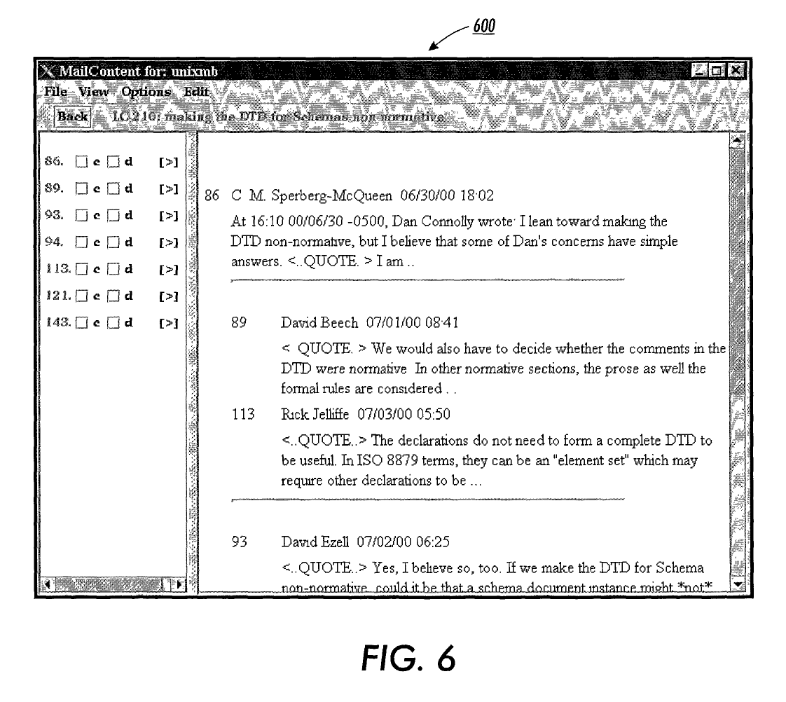

FIG. 6 shows an thread-level display 600 that was obtained by selecting an encapsulated thread on a first or second level display in accordance with one embodiment of the present invention. The display 600 represents an adaptation of the single-document thread displays described in the co-pending, co-assigned patent application entitled METHOD AND SYSTEM FOR DISPLAY OF ELECTRONIC MAIL, wherein threads are presented as single documents with varying, user-selected amounts of embedded text. Here, these selections are made via menu choices associated with the “view” menu button.

Another embodiment of the present invention may include a tool button (not shown) on the inbox display to promote a particular thread on a second or third-level display from encapsulation within a category to a top level. Such a specification would allow selection of important threads within otherwise low-priority categories for special display treatment without the need to define additional rules.

As illustrated in FIG. 1, the computer controlled display system is implemented either on a single program general purpose computer, or separate program general purpose computer. However, the computer controlled display system can also be implemented on a special purpose computer, a programmed microprocessor or microcontroller and peripheral integrated circuit element, an ASIC or other integrated circuit, a digital signal processor, a hard wired electronic or logic circuit such as a discrete element circuit, a programmable logic device such as a PLD, PLA, FPGA, PAL, or the like.

Furthermore, the disclosed method may be readily implemented in software using object or object-oriented software development environments that provide portable source code that can be used on a variety of computer or workstation hardware platforms. Alternatively, the disclosed computer controlled display system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The computer controlled display systems and methods described above, however, can be readily implemented in hardware and/or software using any known or later-developed systems or structures, devices and/or software by those skilled in the applicable art without undue experimentation from the functional description provided herein together with a general knowledge of the computer arts.

Moreover, the disclosed methods may be readily implemented as software executed on a programmed general purpose computer, a special purpose computer, a microprocessor, or the like. In this instance, the methods and systems of this invention can be implemented as a routine embedded on a personal computer such as a Java® or CGI script, as a resource residing on a server or graphics workstation, as a routine embedded in a dedicated computer controlled display system, a web browser, an electronic message enabled cellular phone, a PDA, a dedicated computer controlled display system, or the like. The computer controlled display system can also be implemented by physically incorporating the system and method into a software and/or hardware system, such as the hardware and software systems of a dedicated computer controlled display system.

It is, therefore, apparent that there has been provided, in accordance with the present invention, systems and methods for computer controlled display. While this invention has been described in conjunction with embodiments thereof, it is evident that many alternatives, modifications and variations be apparent to those skilled in the applicable arts. Accordingly, Applicants intend to embrace all such alternatives, modifications and variations that follow within the spirit and scope of this invention.

What is claimed is:

1. A method for displaying an e-mail collection comprising:
receiving a sequence of e-mail messages;
categorizing each e-mail message into at least one of a plurality of categories; and
displaying each of the categorized messages in accordance with a display specification, wherein the display specification specifies how each of the plurality of categories are displayed.

2. The method of claim 1, further comprising:
receiving at least one of a plurality of definitions for display specifications from a user; and
receiving a user selection of one of the plurality of display specifications, wherein the displaying of the e-mail messages is in accordance with the user selected display specification.

3. The method of claim 1, wherein the display specification provides for the display of the e-mail messages in one of the plurality of categories by encapsulating the messages into threads and for providing at least one item on the top level display for each of the corresponding threads.

4. The method of claim 1, wherein the display specification provides for the display of the e-mail messages in one of the plurality of categories by encapsulating the messages in the corresponding category and for providing at least one item on the top level display for the corresponding category.

5. The method of claim 1, wherein the display specification includes a plurality of user-defined rule-based categories, wherein one of the plurality of user-defined rule-based categories is nested within another of the plurality of user-defined rule-based categories and wherein the nested user-defined rule-based category is displayed differently than the another of the plurality of user-defined rule-based categories.

6. The method of claim 1, further comprising:
providing an editor window display which lists the plurality of categories and a plurality of message display alternatives for each of the plurality of categories; and
receiving a user selection of one of the plurality of message display alternatives for one of the plurality of categories.

7. The method of claim 1, further comprising:
providing a tool button that is adapted to receive a user command to perform an operation on messages associated with an identified item; and
performing the operation on the messages associated with the identified item in response to a user operation of the tool button.

8. A computer controlled display system for displaying an e-mail collection, the system comprising:
a display for presenting the e-mail collection on a viewing area of the display; and
a processor that is adapted to receive a sequence of e-mail messages in the e-mail collection; to categorize each e-mail message into at least one of a plurality of categories; and to control the display to display each of the categorized messages in accordance with a display specification, wherein the display specification specifies how each of the plurality of categories are displayed.

9. The system of claim 8, wherein the processor is further adapted to:
receive at least one of a plurality of definitions for display specifications from a user;
receive a plurality of display specifications from the user; and
receive a user selection of one of the plurality of display specifications, wherein the display of e-mail messages is in accordance with the user selected display specification.

10. The system of claim 8, wherein the display specification provides for the display of the e-mail messages in one of the plurality of categories by encapsulating the messages into threads and for providing one item on the top level display for each of the corresponding threads.

11. The system of claim 8, wherein the display specification provides for the display of the e-mail messages in one of the plurality of categories by encapsulating the messages in the corresponding category and for providing at least one item on the top level display for the corresponding category.

12. The system of claim 8, wherein the display specification includes a plurality of user-defined rule-based definitions of categories, wherein at least one of the plurality of user-defined rule-based categories is nested within another of the plurality of user-defined rule-based categories, and wherein the nested user-defined rule-based category is displayed differently than the another of the plurality of user-defined rule-based categories.

13. The system of claim 8, wherein the processor is further adapted:
to provide an editor window display which lists the plurality of categories and a plurality of message display alternatives for each of the plurality of categories;
to receive a user selection of one of the plurality of message display alternatives for one of the plurality of categories.

14. The system of claim 8, wherein the processor is further adapted:
to provide a tool button that is adapted to receive a user command to delete messages associated with an identified item; and
to delete the messages associated with the identified item in response to a user operation of the tool button.

15. The system of claim 8, wherein the processor is further adapted:
to receive a user command from a tool button; and
to perform the operation on the messages associated with the identified item in response to a user operation of the tool button.

16. An information storage media comprising information that displays an e-mail collection, the information comprising:
information that receives a sequence of e-mail messages in the e-mail collection;
information that categorizes each e-mail message into at least one of a plurality of categories; and
information that displays each of the categorized messages in accordance with a display specification, wherein the display specification specifies how each of the plurality of categories are displayed.

17. The media of claim 16, further comprising:
information that receives at least one of a plurality of definitions for display specifications from a user; and
information that receives a user selection of one of the plurality of display specifications, wherein the displaying of the e-mail messages is in accordance with the user selected display specification.

18. The media of claim 16, wherein the display specification provides for the display of the e-mail messages in one of the plurality of categories by encapsulating the messages into threads and for providing one item on the top level display for each of the corresponding threads.

19. The media of claim 16, wherein the display specification provides for the display of the e-mail messages in one of the plurality of categories by encapsulating the messages in the corresponding category and for providing one item on the top level display for the corresponding category.

20. The media of claim 16, wherein the display specification includes a plurality of user-defined rule-based categories, wherein at least one of the plurality of user-defined rule-based categories is nested within another of the plurality of user-defined rule-based categories, and wherein the nested user-defined rule-based category is displayed differently than the another of the plurality of user-defined rule-based categories.

21. The media of claim 16, further comprising:
information that provides an editor window display which lists the plurality of categories and a plurality of message display alternatives for each of the plurality of categories; and
information that receives a user selection of one of the plurality of message display alternatives for one of the plurality of categories.

22. The media of claim 16, further comprising information that:
receives a user command; and
performs the operation on the messages associated with the identified item in response to a user operation of the tool button.
